(19) United States
(12) Patent Application Publication
(10) Pub. No.: US 2026/0188673 A1
(43) Pub. Date: Jul. 2, 2026

(54) ELECTRODE ACTIVE MATERIAL AND ALL SOLID BATTERY

(71) Applicant: TAIYO YUDEN CO., LTD., Tokyo (JP)

(72) Inventor: Taiki SUEMATSU, Tokyo (JP)

(73) Assignee: TAIYO YUDEN CO., LTD., Tokyo (JP)

(21) Appl. No.: 19/415,320

(22) Filed: Dec. 10, 2025

(30) Foreign Application Priority Data
Dec. 26, 2024 (JP) 2024-230789

(51) Int. Cl. H01M 4/58; C01G 33/00; C01G 35/00; H01M 10/0525; H01M 10/0562; H01M 10/0585

(52) U.S. Cl. CPC H01M 4/5825; C01G 33/006; C01G 35/006; H01M 10/0525; H01M 10/0562; H01M 10/0585; C01P 2002/50; C01P 2006/40; H01M 2300/0068

(57) ABSTRACT

An electrode active material includes an anode active material which is represented by a composition formula of Al₁₋ₓMₓNb_{11-y}N_{y}O₂₉, where x satisfies 0<x<0.5, y satisfies 0≤y<5, M is a tetravalent transition metal element, and N is a pentavalent or higher transition metal element.

### CROSS-REFERENCE TO RELATED APPLICATION

This application is based upon and claims the benefit of priority of the prior Japanese Patent Application No. 2024-230789, filed on Dec. 26, 2024, the entire contents of which are incorporated herein by reference.

### FIELD

A certain aspect of the present invention relates to an electrode active material and an all solid battery.

### BACKGROUND

In recent years, all solid batteries have come into use as secondary batteries with high energy density. These all solid batteries are required to be smaller and lighter, with high capacity and high energy density, and therefore electrode active materials with high capacity and high output are being developed (see, for example, International Publication No. 2022/080083, Japanese Patent Application Publication No. 2010-287496, International Publication No. 2022/185717, Japanese Patent Application Publication No. 2024-50182 and Appl. Mater. Interface. 2019; 11(6): 6089-6096.).

### SUMMARY OF THE INVENTION

According to an aspect of the present invention, there is provided an electrode active material including: an anode active material which is represented by a composition formula of Al₁₋ₓMₓNb_{11-y}N_{y}O₂₉, where x satisfies 0≤x<0.5, y satisfies 0≤y<5, M is a tetravalent transition metal element, and N is a pentavalent or higher transition metal element.

### BRIEF DESCRIPTION OF THE DRAWINGS

FIG. 1 illustrates a schematic cross section of a basic structure of an all solid battery;

FIG. 2 illustrates a schematic cross section;

FIG. 3 illustrates a schematic cross section of an all solid battery of an embodiment;

FIG. 4 illustrates a schematic cross section of another all solid battery;

FIG. 5 illustrates a flowchart of a manufacturing method of an all solid battery;

FIG. 6A and FIG. 6B illustrate a stacking process; and

FIG. 7 is a schematic cross section of a basic structure of a lithium-ion battery.

### DETAILED DESCRIPTION

While AlNb₁₁O₂₉ has a high volumetric capacity, it has a problem of being difficult to achieve high rate characteristics and high cycle characteristics.

(First Embodiment) An electrode active material according to a first embodiment will be described below with reference to the drawings.

The electrode active material according to this embodiment includes an anode active material. Graphite-based anode active materials are primarily used in typical Li-ion batteries. However, because the operating potential of graphite-based materials is close to the Li deposition potential, there is a risk of internal short-circuiting due to Li deposition during charge and discharge. Therefore, the use of oxide-based anode active materials is considered. Oxide-based anode active materials have a higher operating potential than graphite-based anode active materials and do not cause lithium deposition, thereby providing safe batteries that do not cause internal short-circuiting during charge and discharge. However, a drawback of oxide-based anode active materials is their low capacity.

The oxide-based anode active material is such as TiNb₂O₇ or AlNb₁₁O₂₉. However, TiNb₂O₇ has a problem is cycle characteristics and rate characteristics when used in all solid batteries. While AlNb₁₁O₂₉ achieves a higher volumetric capacity than TiNb₂O₇, it has a problem in cycle characteristics and rate characteristics.

Through extensive research, the inventors have discovered that an oxide in which a portion of the Al in AlNb₁₁O₂₉ is replaced with a tetravalent transition metal element (hereinafter referred to as transition metal element M) achieves a high volumetric capacity as well as high rate and cycle characteristics. This is because the substitution of the tetravalent transition metal element M for the trivalent Al site introduces vacancies into the crystal lattice, improving conductivity and structural stability.

However, if the Al composition ratio is reduced, there is a risk that sufficient volumetric capacity is not achieved. Therefore, in this embodiment, an upper limit is set on the content of the transition metal element M. Specifically, in this embodiment, an oxide represented by the composition formula Al₁₋ₓMₓNb₁₁O₂₉, where x satisfies the range 0<x<0.5, is used as the anode active material. This achieves a high volumetric capacity, resulting in high rate and cycle characteristics.

For example, if XRD (X-ray diffraction) measurements are performed on Al₁₋ₓMₓNb₁₁O₂₉ powder containing different amounts of transition metal element M, and Rietveld analysis is performed to calculate the lattice constant, and the resulting lattice constant and volume are plotted, they will fall on a straight line (Vegard's law), confirming that Al has been substituted with the transition metal element M. Furthermore, Al₁₋ₓMₓNb₁₁O₂₉ belongs to the space group C2/m.

From the viewpoint of sufficiently improving volumetric capacity, rate characteristics and cycle characteristics, x in the Al₁₋ₓMₓNb₁₁O₂₉ composition formula is preferably 0.05 or greater, preferably 0.07 or greater, and more preferably 0.10 or greater.

On the other hand, if the amount of substitution by the transition metal element Mis too high, there is a risk of deterioration in rate characteristics and cycle characteristics. Therefore, it is preferable to set an upper limit for x in the Al₁₋ₓMₓNb₁₁O₂₉ composition formula. In this embodiment, x is preferably 0.2 or less, and more preferably 0.15 or less.

The transition metal element M is such as Hf (hafnium), Sn (tin), Ti (titanium), Zr (zirconium), V (vanadium), Ce (cerium), Mo (molybdenum), W (tungsten), Pr (praseodymium), or Ru (ruthenium).

The electrode active material may contain an electrode active material other than the anode active material represented by the composition formula Al₁₋ₓMₓNb₁₁O₂₉. However, it is preferable that the anode active material represented by the composition formula Al₁₋ₓMₓNb₁₁O₂₉ is the primary component of the electrode active material. For example, the anode active material represented by the composition formula Al₁₋ₓMₓNb₁₁O₂₉ preferably accounts for 80% or more by volume, and more preferably 90% or more by volume.

Furthermore, by substituting a portion of the Nb with a transition metal element with a valence of 5 or higher (hereinafter referred to as the transition metal element N), a high volumetric capacity is achieved, high rate characteristics and high cycle characteristics are realized, and reaction with the solid electrolyte during firing is reduced. Therefore, it is preferable to use an anode active material in which a portion of the Nb in the composition formula Al₁₋ₓMₓNb₁₁O₂₉ is substituted with the transition metal element N. Specifically, it is preferable to use an anode active material represented by the composition formula Al₁₋ₓMₓNb_{11-y}N_{y}O₂₉ (0≤y<5).

From the viewpoint of the single-phase ratio, it is preferable that x<y in the composition formula Al₁₋ₓMₓNb_{11-y}N_{y}O₂₉.

From the viewpoint of sufficiently improving rate characteristics and cycle characteristics, it is preferable that y in the composition formula Al₁₋ₓMₓNb_{11-y}N_{y}O₂₉ is 0.5 or greater, and more preferably 1.0 or greater.

On the other hand, if y in the composition formula Al₁₋ₓMₓNb_{11-y}N_{y}O₂₉ is too large, there is a risk of a decrease in volumetric capacity. Therefore, it is preferable to set an upper limit for y. In this embodiment, it is more preferable that y is 3.0 or less, and even more preferably 2.5 or less.

As the transition metal element N, Ta (tantalum), Mo (pentavalent molybdenum), W (pentavalent tungsten) or the like can be used.

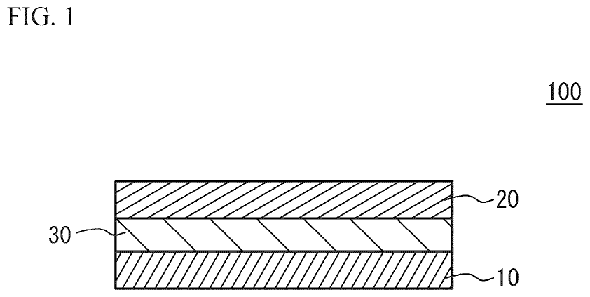

(Second Embodiment) FIG. 1 is a schematic cross-sectional view of the basic structure of an all solid battery 100 according to a second embodiment. As illustrated in FIG. 1, the all solid battery 100 has a structure in which a solid electrolyte layer 30 is sandwiched between a first internal electrode 10 (first electrode layer) and a second internal electrode 20 (second electrode layer). The first internal electrode 10 is formed on a first main surface of the solid electrolyte layer 30. The second internal electrode 20 is formed on a second main surface of the solid electrolyte layer 30. The first internal electrode 10, the solid electrolyte layer 30, and the second internal electrode 20 are sintered bodies of powder materials.

When the all solid battery 100 is used as a secondary battery, one of the first internal electrode 10 and the second internal electrode 20 is used as a positive electrode, and the other is used as a negative electrode. In this embodiment, as an example, the first internal electrode 10 is used as a positive electrode, and the second internal electrode 20 is used as a negative electrode.

A main component of the solid electrolyte layer 30 is a solid electrolyte having ionic conductivity. The solid electrolyte of the solid electrolyte layer 30 is an oxide-based solid electrolyte having lithium ion conductivity. The solid electrolyte is, for example, phosphoric acid salt-based electrolyte having a NASICON crystal structure. For example, the solid electrolyte of the solid electrolyte layer 30 is oxide-based solid electrolyte having lithium ion conductivity. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like.

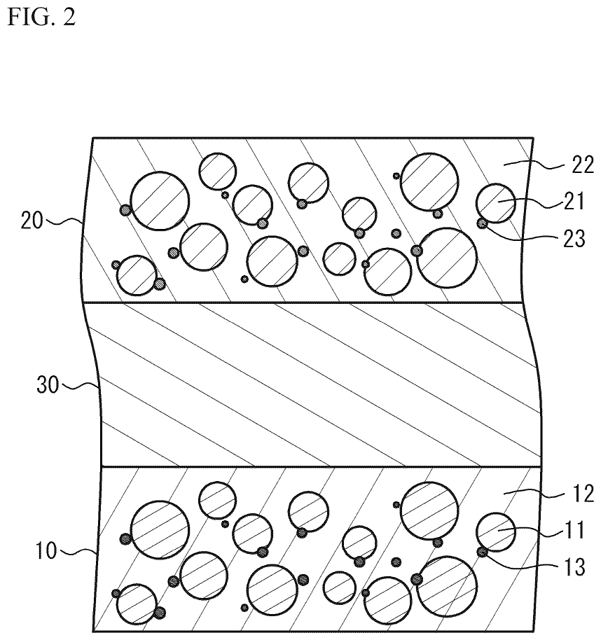

As illustrated in FIG. 2, the first internal electrode 10 has a structure in which an electrode active material 11, a solid electrolyte 12, a conductive additive 13, and the like are dispersed. The second internal electrode 20 has a structure in which an electrode active material 21, a solid electrolyte 22, a conductive additive 23, and the like are dispersed. By providing the first internal electrode 10 with the electrode active material 11 and the second internal electrode 20 with the electrode active material 21, the all solid battery 100 can be used as a secondary battery. By providing the first internal electrode 10 with the solid electrolyte 12 and the second internal electrode 20 with the solid electrolyte 22, ionic conductivity is achieved in the first internal electrode 10 and the second internal electrode 20. By providing the first internal electrode 10 with the conductive additive 13 and the second internal electrode 20 with the conductive additive 23, conductivity is achieved in the first internal electrode 10 and the second internal electrode 20. The solid electrolytes 12, 22 may be the same solid electrolyte as the solid electrolyte layer 30, for example, or may be different solid electrolytes.

The electrode active material 11 is, for example, an electrode active material with an olivine crystal structure. The electrode active material is such as a phosphate containing a transition metal and lithium. The olivine crystal structure is a crystal found in natural olivine and can be identified by X-ray diffraction.

A typical example of the electrode active material with the olivine crystal structure is LiCoPO₄, which contains Co. Phosphates in which the Co in this chemical formula is replaced by a transition metal can also be used. The ratio of Li and PO₄ can vary depending on the valence. Note that Co, Mn, Fe, Ni or the like are preferably used as transition metals.

Carbon materials and the like are used as the conductive additives 13 and 23. Metals may also be used as the conductive additives 13 and 23. The conductive additive metal is such as Pd, Ni, Cu, Fe, or an alloy containing one of these.

In this embodiment, the electrode active material described in the first embodiment is used as the electrode active material 21. Specifically, an anode active material represented by the composition formula Al₁₋ₓMₓNb_{11-y}N_{y}O₂₉ (0<x<0.5, 0<y<5) is used. This achieves a high volumetric capacity, high rate characteristics, and high cycle characteristics, and has the effect of reducing reaction with the solid electrolyte during sintering.

In the second internal electrode 20, if the average grain size of the electrode active material 21 is too large, the internal resistance of the electrode may increase, making high-speed charging and discharging difficult. If the average grain size is too small, in addition to increasing reactivity during heat treatment, it may also hinder the sintering and densification of the solid electrolyte. Therefore, the average grain size of the electrode active material 21 in the second internal electrode 20 is preferably 0.5 μm or more and 10 μm or less, more preferably 0.7 μm or more and 6.0 μm or less, and even more preferably 1.0 μm or more and 4.0 μm or less.

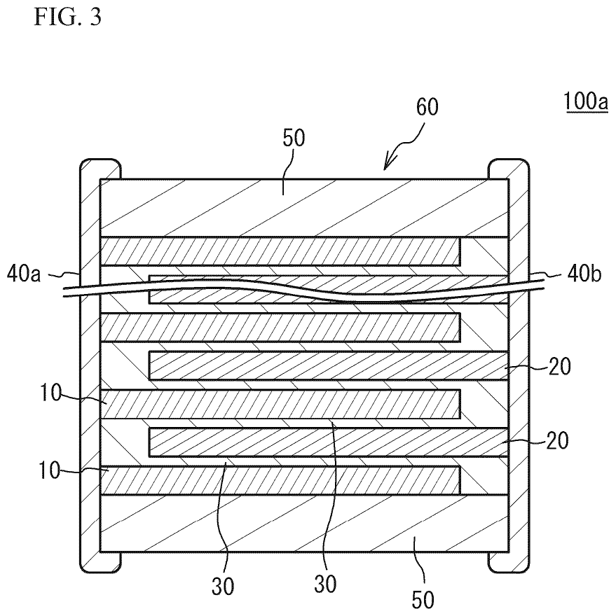

(Stack type all solid battery) FIG. 3 is a schematic partial cross-sectional view of a stacked all solid battery 100a in which a plurality of battery units are stacked. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of first internal electrodes 10 and the plurality of second internal electrodes 20 are alternately stacked with the solid electrolyte layers 30 in between. The edges of the plurality of first internal electrodes 10 are exposed to the first end face of the multilayer chip 60 and are not exposed to the second end face. The edges of the plurality of second internal electrodes 20 are exposed to the second end face of the multilayer chip 60 and are not exposed to the first end face. Thereby, the first internal electrode 10 and the second internal electrode 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper surface of the multilayer structure of the first internal electrode 10, the solid electrolyte layer 30, and the second internal electrode 20 (in the example of FIG. 3, the upper surface of the uppermost first internal electrode 10). Further, the cover layer 50 is also stacked on the lower surface of the multilayer structure (in the example of FIG. 3, the lower surface of the lowermost first internal electrode 10). The cover layer 50 is mainly composed of an inorganic material (for example, Al₂O₃, ZrO₂, TiO₂ or the like) containing Al, Zr, Ti or the like. The cover layer 50 may contain the main component of the solid electrolyte layer 30 as a main component. The cover layer 50 is a sintered body.

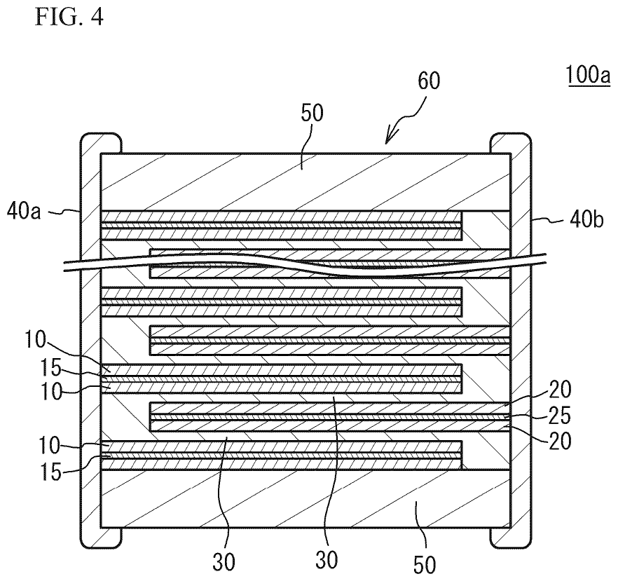

Each of the first internal electrode 10 and the second internal electrode 20 may include a current collector layer. For example, as illustrated in FIG. 4, a first current collector layer 15 may be provided within the first internal electrode 10. Further, a second current collector layer 25 may be provided within the second internal electrode 20. The first current collector layer 15 and the second current collector layer 25 have a conductive material as a main component. For example, metal, carbon, or the like can be used as the conductive material for the first current collector layer 15 and the second current collector layer 25. By connecting the first current collector layer 15 to the first external electrode 40a and connecting the second current collector layer 25 to the second external electrode 40b, current collection efficiency is improved.

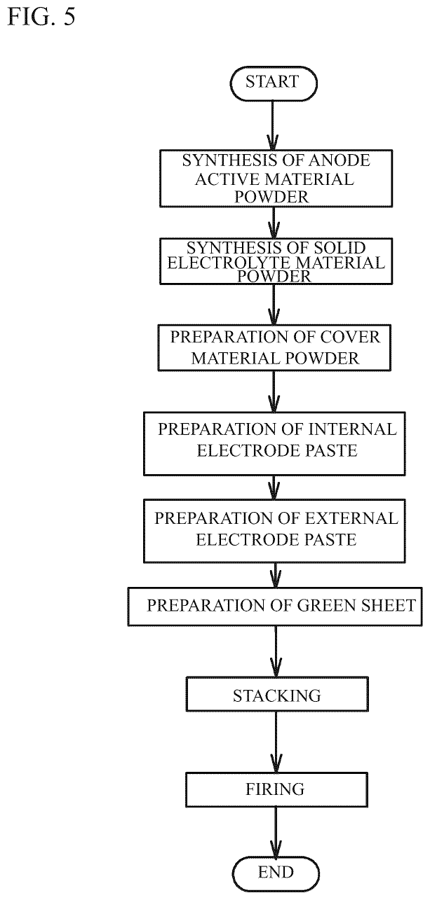

A description will be given of a manufacturing method of the all solid battery 100a described on the basis of FIG. 3. FIG. 5 illustrates a flowchart of the manufacturing method of the all solid battery 100a.

(Synthesis process of anode active material powder) Raw materials such as AlNb₁₁O₂₉, oxide of transition metal element M, and oxide of transition metal element N are weighed and mixed to form Al₁₋ₓMₓNb_{11-y}N_{y}O₂₉ (0<x<0.5, 0<y<5). After mixing, the mixture is calcined in air at 1100° C., and the resulting calcined powder is crushed again. It is then heat-treated in air at a temperature of 1300° C. or higher to obtain the desired Al₁₋ₓMₓNb_{11-y}N_{y}O₂₉ (0<x<0.5, 0<y<5) composite powder. The composite powder is crushed again and sieved through a #150 stainless steel mesh to produce the anode active material powder.

(Synthesis process of solid electrolyte material powder) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm φ.

(Preparation process of cover material powder) First, the ceramic raw powder for the cover layer 50 is prepared. For example, raw materials and additives are mixed together, and the raw powder for the cover layer can be prepared using a solid-phase synthesis method. The resulting raw powder can be dry-milled to adjust the average particle size to the desired size. For example, a planetary ball mill using 5 mm diameter ZrO₂ balls can be used to adjust the average particle size to the desired size.

(Preparation process of internal electrode paste) Next, internal electrode pastes for making the first internal electrode 10 and the second internal electrode 20 described above are separately made. For example, the internal electrode paste can be obtained by uniformly dispersing a conductive auxiliary agent, an electrode active material, a solid electrolyte material, a sintering assistant, a binder, a plasticizer, and the like in water or an organic solvent. The above-mentioned solid electrolyte paste may be used as the solid electrolyte material. A carbon material or the like may be used as the conductive assistant. A metal may be used as the conductive assistant. An example of the metal of the conductive assistant is such as Pd, Ni, Cu, Fe, or alloys containing these. Pd, Ni, Cu, Fe, alloys containing these, and various carbon materials may also be used. When the first internal electrode 10 and the second internal electrode 20 have different compositions, the internal electrode pastes may be prepared separately. When the electrode active material 21 of the second internal electrode 20 contains multiple types of anode active materials, the multiple types of anode active materials may be contained in the internal electrode paste.

The sintering assistant includes one or more of glass components such as Li—B—O-based compound, Li—Si—O-based compound, Li—C—O-based compound, Li—S—O-based compound and Li—P—O-based compound.

(Preparation process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Preparation process of green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

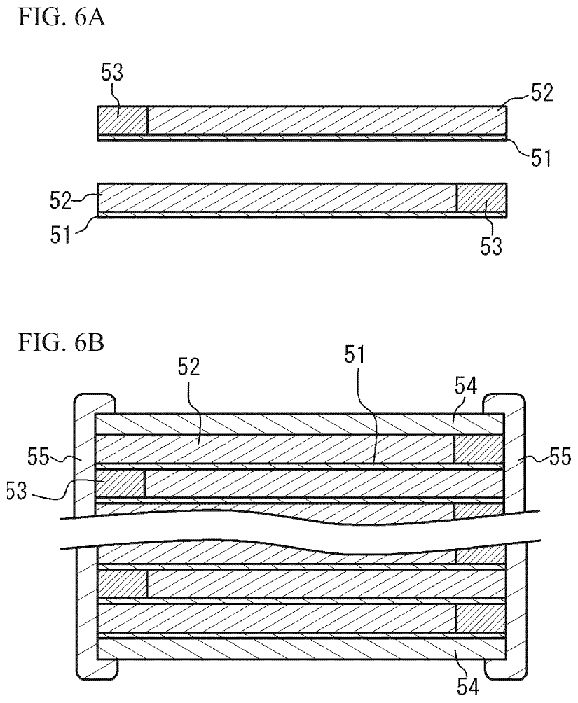

(Stacking process) As illustrated in FIG. 6A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 ca be used as the reverse pattern 53. The solid electrolyte green sheet 51 after the printing can be used as a stack unit. The plurality of solid electrolyte green sheets 51 are stacked so as to be alternately shifted. As illustrated in FIG. 6B, a multilayer structure is obtained by pressing a cover sheet 54 from above and below in the stacking direction. In this case, in the multilayer structure, the internal electrode paste 52 for the first internal electrode 10 is exposed on one end surface, and the internal electrode paste 52 for the second internal electrode 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

By sequentially stacking the internal electrode paste, the current collector paste containing a conductive material, and the internal electrode paste, a current collector layer can be formed in the first internal electrode 10 and the second internal electrode 20.

The manufacturing method according to this embodiment uses an anode active material having the composition formula Al₁₋ₓMₓNb_{11-y}N_{y}O₂₉ (0<x<0.5, 0<y<5), thereby suppressing the reaction between the anode active material and the solid electrolyte during firing. This allows the all solid battery 100a to achieve a high volumetric capacity, high rate characteristics, and excellent cycle characteristics.

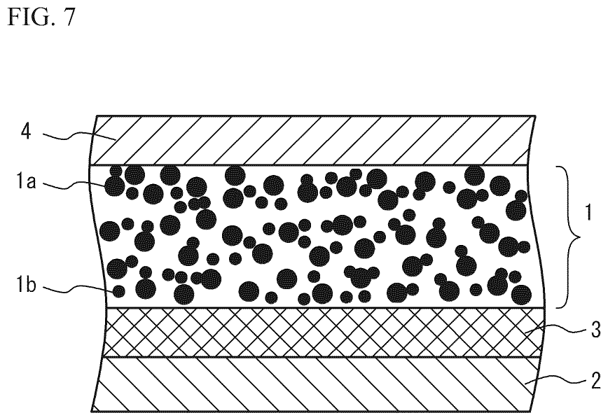

(Third Embodiment) FIG. 7 is a schematic cross section of the basic structure of a lithium-ion battery according to the second embodiment. As illustrated in FIG. 7, the lithium-ion battery includes a separator 3 disposed on a Li metal 2, which functions as a counter electrode. A positive electrode 1 is disposed on the separator 3, and a current collector 4 is disposed on the positive electrode 1. The positive electrode 1 and the separator 3 are impregnated with an electrolyte liquid. The positive electrode 1 and the Li metal 2 are shielded by the separator 3. The positive electrode 1 contains an electrode active material 1a, a conductive powder 1b, and a binder. The conductive powder 1b is, for example, a conductive material such as acetylene black. The current collecting member 4 is, for example, aluminum foil. The binder is not illustrated.

The electrode active material 1a is the electrode active material described in the first embodiment. Specifically, an anode active material represented by the composition formula Al₁₋ₓMₓNb_{11-y}N_{y}O₂₉ (0<x<0.5, 0≤y<5) is used. This achieves a high volumetric capacity, as well as high rate and cycle characteristics.

### EXAMPLES

(Example 1) The raw materials were weighed and crushed and mixed to achieve the composition ratio of Al_{0.95}Hf_{0.05}Nb₁₁O₂₉. After mixing, the mixture was calcined in air at 1100° C. The calcined powder was crushed again and further heat-treated in air at 1300° C. to obtain the desired Al_{0.95}Hf_{0.05}Nb₁₁O₂₉ composite powder. The composite powder was crushed again and sieved through a #150 stainless steel mesh to obtain the anode active material powder.

The anode active material powder, PVdF binder, and acetylene black were mixed in a weight ratio of 80:10:10 and diluted with NMP to prepare an electrode slurry, which was then coated onto aluminum foil. A negative electrode half-cell was constructed with a metallic lithium foil as the counter electrode, sandwiching a separator between them. The half-cell was sealed in a 2032 coin cell using 1 M LiPF6 in EC:DEC (1:2 vol %) as the electrolyte. DEC is diethyl carbonate. EC is ethylene carbonate.

(Example 2) The raw materials were weighed and crushed to achieve a composition ratio of Al_{0.9}Hf_{0.1}Nb₁₁O₂₉. Other conditions were the same as in Example 1.

(Example 3) The raw materials were weighed and crushed to achieve a composition ratio of Al_{0.85}Hf_{0.15}Nb₁₁O₂₉. Other conditions were the same as in Example 1.

(Example 4) The raw materials were weighed and crushed to achieve a composition ratio of Al_{0.8}Hf_{0.2}Nb₁₁O₂₉. Other conditions were the same as in Example 1.

(Example 5) The raw materials were weighed and crushed to achieve a composition ratio of Al_{0.95}Hf_{0.05}Nb₉Ta₂O₂₉. Other conditions were the same as in Example 1.

(Example 6) The raw materials were weighed, crushed, and mixed to achieve a composition ratio of Al_{0.90}Hf_{0.1}Nb₉Ta₂O₂₉. Other conditions were the same as in Example 1.

(Example 7) The raw materials were weighed and crushed to achieve a composition ratio of Al_{0.85}Hf_{0.15}Nb₉Ta₂O₂₉. Other conditions were the same as in Example 1.

(Example 8) The raw materials were weighed and crushed to achieve a composition ratio of Al_{0.8}Hf_{0.2}Nb₉Ta₂O₂₉. Other conditions were the same as in Example 1.

(Comparative Example 1) The raw materials were weighed and crushed to achieve a composition ratio of AlNb₁₁O₂₉. Other conditions were the same as in Example 1.

(Comparative Example 2) The raw materials were weighed and crushed to achieve a composition ratio of Al_{0.5}Hf_{0.5}Nb₁₁O₂₉. Other conditions were the same as in Example 1.

(Comparative Example 3) The raw materials were weighed, crushed, and mixed to achieve a composition ratio of Al_{0.9}Hf_{0.1}Nb₆Ta₅O₂₉. Other conditions were the same as in Example 1.

(Discharge Capacity) The discharge capacity was measured for each of Examples 1 to 8 and Comparative Examples 1 to 3. The discharge capacity was measured by performing CC charge/discharge at 0.2 C in a thermostatic chamber at 25° C. with a cutoff potential of 1.0 V-3.0 V (vs. Li/Li⁺). The discharge capacities were 1148 mAh/cm³ in Example 1, 1160 mAh/cm³ in Example 2, 1134 mAh/cm³ in Example 3, 1201 mAh/cm³ in Example 4, 999 mAh/cm³ in Example 5, 1032 mAh/cm³ in Example 6, 1068 mAh/cm³ in Example 7, 1005 mAh/cm³ in Example 8, 1122 mAh/cm³ in Comparative Example 1, 1059 mAh/cm³ in Comparative Example 2, and 263 mAh/cm³ in Comparative Example 3.

If the discharge capacity was 990 mAh/cm³ or greater, the discharge capacity was judged as acceptable (o); if the discharge capacity was less than 990 mAh/cm³, the discharge capacity was judged as unacceptable (x). The discharge capacities of Examples 1-8 and Comparative Examples 1 and 2 were judged as acceptable (o). The discharge capacity of Comparative Example 3 was judged as unacceptable (x). This is believed to be due to the fact that much of the Nb was replaced with Ta, resulting in y≥5, resulting in a rapid increase in the proportion of secondary phase and a decrease in the proportion of active material.

(Cycle Characteristics) The cycle characteristics of each of Examples 1 to 8 and Comparative Examples 1-3 were measured. The cycle characteristics were evaluated by calculating the capacity retention rate from the initial discharge capacity after 100 cycles of 0.2 C CC charge/discharge with a cutoff potential of 1.0 V to 3.0 V (vs. Li/Li⁺) in a 25° C. thermostatic chamber. The capacity retention rates after 100 cycles were 82.2% for Example 1, 83.8% for Example 2, 84.1% for Example 3, 82.5% for Example 4, 91.2% for Example 5, 92.9% for Example 6, 92.6% for Example 7, 91.7% for Example 8, 80.5% for Comparative Example 1, 81.6% for Comparative Example 2, and 89.5% for Comparative Example 3.

If the capacity retention rate after 100 cycles was 81% or higher, the cycle characteristics were judged as acceptable (o). If the capacity retention rate after 100 cycles was less than 81%, the cycle characteristics were judged as unacceptable (x). The cycle characteristics of Examples 1 to 8 and Comparative Examples 2 and 3 were judged as acceptable (o). On the other hand, the cycle characteristics of Comparative Example 1 were judged as unacceptable (x). This is thought to be because much of the Al was replaced with Hf, resulting in x≥0.5, and significant cycle degradation of the electrode.

(Rate Characteristics) The rate characteristics were investigated for each of Examples 1 to 8 and Comparative Examples 1 to 3. Specifically, the capacity ratio at a discharge rate of 5 C relative to a 0.5 C discharge was measured. The rate characteristics were 81.5% for Example 1, 82.2% for Example 2, 81.9% for Example 3, 81.8% for Example 4, 82.4% for Example 5, 84.4% for Example 6, 83.7% for Example 7, 82.9% for Example 8, 81.0% for Comparative Example 1, 72.2% for Comparative Example 2, and 68.2% for Comparative Example 3.

If the rate characteristics exceeded 81%, the rate characteristics were judged as acceptable (o). If the rate characteristics were 81% or less, the rate characteristics were judged as unacceptable (x). The rate characteristics of Examples 1 to 8 were judged as acceptable (o). On the other hand, the rate characteristics of Comparative Example 1 were judged as unacceptable (x). This is thought to be because a portion of the Al was not replaced, resulting in no improvement in rate characteristics. The rate characteristics of Comparative Example 2 were also judged as unacceptable (x). This is thought to be because much of the Al was replaced with Hf, resulting in x≥0.5, and the rate characteristics of the electrode were significantly degraded. The rate characteristics of Comparative Example 3 were also judged as unacceptable (x). This is thought to be because much of the Nb was replaced with Ta, resulting in y≥5, resulting in a secondary phase that degraded rate characteristics.

(Overall Judgment) If all of the discharge capacity, cycle characteristics, and rate characteristics were judged as acceptable, the overall judgment was judged as acceptable (O). If any one of them was judged as unacceptable, the overall judgment was judged as unacceptable (x). The overall judgement was judged as acceptable (o) in all of Examples 1 to 8. This is believed to be due to the use of an anode active material with a composition formula of Al₁₋ₓMₓNb_{11-y}N_{y}O₂₉ (0<x<0.5, 0≤y<11). On the other hand, the overall judgement was judged as unacceptable (x) in Comparative Example 1. This is believed to be due to the absence of Al substitution. The overall judgement was judged as unacceptable (x) in Comparative Example 2. This is believed to be due to x≥0.5. The overall judgement was judged as unacceptable (x) in Comparative Example 3. This is believed to be due to y≥5. The results are shown in Table 1.

TABLE 1

| | | | | CAPACITY | | RATE | | |
|---|---|---|---|---|---|---|---|---|
| | | DISCHARGE | | RETENSION | | CHARACTERISTICS | | |
| | | CAPACITY | | RATE AFTER | | 5C/0.5C CAPACITY | | |
| | COMOSITION | (mAh/cm³) | | 100 CYCLES/% | | RATIO | | OVERALL |
| | FORMULA | RESULT | JDUGE | RESULT | JUDGE | RESULT | JUDGE | JUDGE |
| EXAMPLE 1 | Al_{0.95}Hf_{0.05}Nb₁₁O₂₉ | 1148 | ◯ | 82.2 | ◯ | 81.5% | ◯ | ◯ |
| EXAMPLE 2 | Al_{0.9}Hf_{0.1}Nb₁₁O₂₉ | 1160 | ◯ | 83.8 | ◯ | 82.2% | ◯ | ◯ |
| EXAMPLE 3 | Al_{0.85}Hf_{0.15}Nb₁₁O₂₉ | 1134 | ◯ | 84.1 | ◯ | 81.9% | ◯ | ◯ |
| EXAMPLE 4 | Al_{0.8}Hf_{0.2}Nb₁₁O₂₉ | 1201 | ◯ | 82.5 | ◯ | 81.8% | ◯ | ◯ |
| EXAMPLE 5 | Al_{0.95}Hf_{0.05}Nb₉Ta₂O₂₉ | 999 | ◯ | 91.2 | ◯ | 82.4% | ◯ | ◯ |
| EXAMPLE 6 | Al_{0.90}Hf_{0.1}Nb₉Ta₂O₂₉ | 1032 | ◯ | 92.9 | ◯ | 84.4% | ◯ | ◯ |
| EXAMPLE 7 | Al_{0.85}Hf_{0.15}Nb₉Ta₂O₂₉ | 1068 | ◯ | 92.6 | ◯ | 83.7% | ◯ | ◯ |
| EXAMPLE 8 | Al_{0.8}Hf_{0.2}Nb₉Ta₂O₂₉ | 1005 | ◯ | 91.7 | ◯ | 82.9% | ◯ | ◯ |
| COMPARATIVE | AlNb₁₁O₂₉ | 1122 | ◯ | 80.5 | X | 81.0% | X | X |
| EXMAPLE 1 | | | | | | | | |
| COMPARATIVE | Al_{0.5}Hf_{0.5}Nb₁₁O₂₉ | 1059 | ◯ | 81.6 | ◯ | 72.2% | X | X |
| EXMAPLE 2 | | | | | | | | |
| COMPARATIVE | Al_{0.9}Hf_{0.1}Nb₀Ta₅O₂₉ | 263 | X | 89.5 | ◯ | 68.2% | X | X |
| EXMAPLE 3 | | | | | | | | |

(Example 9) Raw materials were weighed and crushed and mixed to achieve the composition ratio of Al_{0.9}Hf_{0.1}Nb₉Ta₂O₂₉. After mixing, the mixture was calcined in air at 1100° C. The calcined powder was crushed again and further heat-treated in air at 1300° C. to obtain the desired Al_{0.9}Hf_{0.1}Nb₉Ta₂O₂₉ composite powder. The composite powder was crushed again and sieved through a #150 stainless steel mesh to obtain the anode active material powder.

Li₁₊ₓAlₓGe₂₋ₓ(PO₄)₃ powder was uniformly dispersed in an aqueous or organic solvent along with binders, dispersants, plasticizers and so on, and wet-pulverized to obtain a solid electrolyte slurry with the desired average particle size. This was then coated to obtain a solid electrolyte green sheet. A paste containing cathode active material powder was then printed onto one solid electrolyte green sheet. A paste containing anode active material powder was then printed onto another solid electrolyte green sheet. Multiple printed solid electrolyte green sheets were stacked, alternating with each other, and fired.

(Reference Example 1) In Reference Example 1, the raw materials were weighed, crushed, and mixed to achieve a composition ratio of Al_{0.9}Hf_{0.1}Nb₁₁O₂₉. Other conditions were the same as in Example 9.

(Reference Example 2) In Reference Example 2, the raw materials were weighed, crushed, and mixed to achieve a composition ratio of AlNb₉Ta₂O₂₉. Other conditions were the same as in Example 9.

(Reaction Temperature with Solid Electrolyte) The reaction temperature with the solid electrolyte was measured for Example 9 and Reference Examples 1 and 2. Specifically, an experiment was conducted in which the anode active material powder was mixed with the solid electrolyte LAGP in a 50:50 volume ratio and heat-treated in air. The temperature at which a different phase began to form was measured as the reaction temperature with the solid electrolyte. The reaction temperatures with the solid electrolyte were 710° C. in Example 9, 660° C. in Reference Example 1, and 710° C. in Reference Example 2. These results demonstrate that substituting a portion of the Nb with Ta enables co-firing with the solid electrolyte.

The discharge capacity and cycle characteristics were investigated using the same methods as in Examples 1 to 8 and Comparative Examples 1 to 3. The cycle characteristics were measured for 30 cycles. In Example 9, a discharge capacity of 858 mAh/cm³ was obtained. In Example 9, a capacity retention rate of 91.1% was achieved. On the other hand, in Reference Example 1, battery operation was not achieved, and cycle characteristics could not be measured. This is thought to be because AlNb₁₁O₂₉ reacted with the solid electrolyte during the firing process, producing other compounds. In Reference Example 2, cycle characteristics comparable to those of Example 9 were not achieved. This demonstrates that substituting a portion of the Al with Hf and a portion of the Nb with Ta in Example 9 enables operation in an all solid battery and improves cycle characteristics. The result are shown in Table 2.

TABLE 2

| | | | AFTER | |
|---|---|---|---|---|
| | | | 30 CYCLES | MAXIMUM |
| | | DISCHARGE | CAPACITY | TEMPERATURE |
| | COMPOSITION | CAPACITY | RETENSION | ALLOWING CO- |
| | FORMULA | mAh/cm³ | RATE/% | FIRING |
| EXAMPLE 9 | Al_{0.9}Hf_{0.1}Nb₉Ta₂O₂₉ | 858 | 91.1 | 710° C. |
| REFERENCE | Al_{0.9}Hf_{0.1}Nb₁₁O₂₉ | 119 | — | 660° C. |
| EXAMPLE 1 | | | | |
| REFERENCE | AlNb₉Ta₂O₂₉ | 849 | 88.6 | 710° C. |
| EXAMPLE 2 | | | | |

Although the embodiments of the present invention have been described in detail, it is to be understood that the various change, substitutions, and alterations could be made hereto without departing from the spirit and scope of the invention.

What is claimed is:

1. An electrode active material comprising:
an anode active material which is represented by a composition formula of Al₁₋ₓMₓNb_{11-y}N_{y}O₂₉, where x satisfies 0<x<0.5, y satisfies 0≤y<5, M is a tetravalent transition metal element, and N is a pentavalent or higher transition metal element.

2. The electrode active material as claimed in claim 1,
wherein x satisfies 0.05≤x.

3. The electrode active material as claimed in claim 1,
wherein x satisfies x≤0.2.

4. The electrode active material as claimed in claim 2,
wherein M is Hf.

5. The electrode active material as claimed in claim 1,
wherein x and y satisfy x<y.

6. The electrode active material as claimed in claim 1,
wherein y satisfies 0.5≤y≤2.5.

7. The electrode active material as claimed in claim 6,
wherein y satisfies y≤2.

8. The electrode active material as claimed in claim 6,
wherein N is Ta.

9. The electrode active material as claimed in claim 1,
wherein the electrode active material contains the anode active material at 80% by volume or more.

10. The electrode active material as claimed in claim 1,
wherein the anode active material is a powder material.

11. The electrode active material as claimed in claim 1,
wherein an average particle size of the electrode active material is 0.5 μm or more and 10 μm or less.

12. The electrode active material as claimed in claim 1,
wherein the electrode active material belongs to a space group C2/m.

13. An all solid battery comprising:
an oxide-based solid electrolyte layer;
a first electrode layer that is provided on a first main face of the oxide-based solid electrolyte layer and includes a cathode active material; and
a second electrode layer that is provided on a second main face of the oxide-based solid electrolyte layer and includes an electrode active material as claimed in claim 1.

14. The all solid battery as claimed in claim 13,
wherein the oxide-based solid electrolyte layer includes a material having a NASICON crystal structure.

15. The all solid battery as claimed in claim 14,
wherein the material having a NASICON crystal structure is a phosphoric acid salt.

16. The all solid battery as claimed in claim 15,
wherein the phosphoric acid salt is Li₁₊ₓAlₓGe₂₋ₓ(PO₄)₃, Li₁₊ₓAlₓZr₂₋ₓ(PO₄)₃, or Li₁₊ₓAlₓT₂₋ₓ(PO₄)₃.
